(19) United States
(12) Patent Application Publication
(10) Pub. No.: US 2013/0001148 A1
(43) Pub. Date: Jan. 3, 2013

(54) FILTER ASSEMBLY

(76) Inventors: Jay R. Osborne, Ham Lake, MN (US); Michael Richard Ekholm, Minneapolis, MN (US); Dan Ganfield, Ramsey, MN (US)

(21) Appl. No.: 13/598,361

(22) Filed: Aug. 29, 2012

Related U.S. Application Data
(63) Continuation-in-part of application No. 13/149,839, filed on May 31, 2011, now Pat. No. 8,292,089.
Application No. 13/149,839 is a continuation of application No. 11/345,155, filed on Feb. 1, 2006, now Pat. No. 7,950,527.

(51) Int. Cl. B01D 29/50

(52) U.S. Cl. 210/323.1

(57) ABSTRACT

A method and apparatus for supporting a screen. The apparatus may comprise a cylindrical screen for submerging in a fluid. The screen may have an inlet pipe for connecting to a piping system, filter members, a first end, a second end, and a support structure. The support structure may include one or more helical and/or straight bar members which traverse the screen.

### CROSS-REFERENCE TO RELATED APPLICATIONS

This application is a continuation-in-part of U.S. patent application Ser. No. 13/149,839, filed May 31, 2011, which is a continuation of U.S. patent application Ser. No. 11/345,155, filed Feb. 1, 2006, the contents of which are herein incorporated by reference in their entirety.

### BACKGROUND OF THE INVENTION

1. Field of the Invention

Embodiments of the invention generally relate to a submerged intake screen. More particularly, embodiments of the invention relate to a screen having a support structure. More particularly still, embodiments of the invention relate to a screen having a helical bar and/or a straight bar support structure.

2. Description of the Related Art

Water collection systems are typically used to provide water to end users such as manufacturing plants, cities, irrigation systems, and power generation facilities located adjacent a body of water such as a river, lake, or salt water bodies. The end users may employ this type of system as an alternative to drilling water well or buying water from a municipality. Additionally, use of these systems may be determined by the location of the end user, for example remote locations where water from a municipal source and/or electrical power to operate pumps is not readily available. These water collection systems have the ability to adapt to varying conditions and deliver water efficiently and economically.

These water collection systems typically use an inlet pipe adapted to transport water from a position submerged in the body of water to the end user adjacent the body of water. An inlet pipe is submerged in the body of water and the end of the inlet pipe is typically coupled to an intake screen which typically has a plurality of filtering members, such as ribs, mesh, or perforations disposed on its outer surface. The filtering members are configured to prevent waterborne debris and aquatic life, of a certain size, from entering the inlet pipe.

Conventional intake filter assemblies typically include an inlet pipe having an open end surrounded by and coupled to a cylindrical screen, which has a central axis that is the same as a longitudinal axis of the inlet pipe. In this way, the cylindrical screen is concentric with the inlet end of the inlet pipe. A typical intake filter assembly may also include a flow modifier pipe within the inlet pipe and extending beyond the inlet pipe into the cylindrical screen. The flow modifier pipe helps evenly distribute the flow of water through the cylindrical screen over the length of the screen.

The flow modifier pipes used now have allowed the overall length of the intake filter to increase while maintaining the intake flow rate below the maximum levels allowed. The increased length of the intake filter has caused structural problems with the intake filter. Previously the intake filters were simply welded to an end cap and a plate connected to the inlet pipe. However, the filter itself is not sufficiently strong enough to support intake and current loads when the length is increased. Attempts have been made to correct this problem using longitudinal support bars in conjunction with optional hoops which follow the filter. However, in order to brace the filter sufficiently a large number of support bars and hoops are required, increasing the overall cost and complexity of each intake filter.

Therefore, a need exist for an intake filter having a support structure which is efficient and inexpensive to build, while maximizing the strength of the filter.

### SUMMARY OF THE INVENTION

Embodiments of the invention generally relate to a submerged filter assembly having a cylindrical screen and a support structure. The cylindrical screen has an inner diameter, a first end and a second end. The support structure supports the cylindrical screen and is configured in a substantially non-longitudinal manner in relation to the screen.

Embodiments of the invention relate to a method of filtering a medium by submerging an intake filter assembly having a cylindrical screen couplable to a piping system, a primary flow modifier, and a support structure having helical members which support the screen. Thereafter, the medium is flowed past the filter assembly and into the piping system.

Embodiments of the invention relate to a filter assembly, comprising an intake member; a support structure coupled to the intake member, wherein the support structure includes a plurality of bars that extend from a first end of the support structure to a second end of the support structure such that the bars form a zig-zag pattern; and a plurality of filter members coupled to the support structure for filtering fluid flow into the intake member.

Embodiments of the invention relate to a filter assembly, comprising an intake member; a support structure coupled to the intake member, wherein the support structure includes a plurality of bars that extend from a first end of the support structure to a second end of the support structure in a non-longitudinal straight line; and a plurality of filter members coupled to the support structure for filtering fluid flow into the intake member.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a front view of a filter assembly with a cut away portion according to an embodiment of the invention.

FIG. 2 is a detail of a support structure connection according to an embodiment of the invention.

FIG. 3 is a cross-sectional end view of a screen and support structure according to an embodiment of the invention.

FIG. 4 is a front view of a filter assembly according to an embodiment of the invention.

FIG. 5 is a front view of a filter assembly according to an embodiment of the invention.

FIGS. 6A and 6B illustrate perspective and sectional views of a support structure according to an embodiment of the invention.

### DETAILED DESCRIPTION

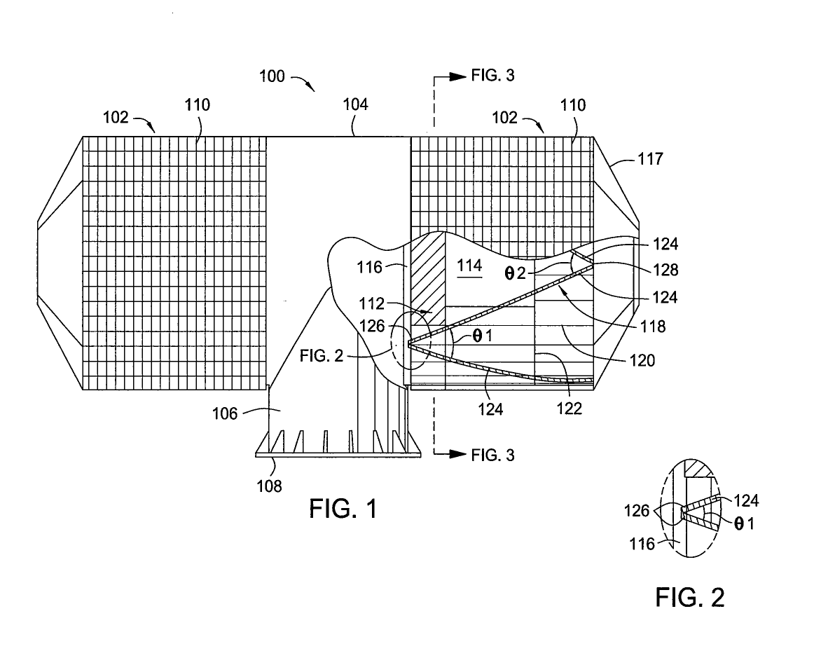

FIG. 1 is a front view of a submerged intake filter assembly 100 according to one embodiment of the present invention. The submerged intake screen includes two cylindrical screens 102 coupled together by a connector pipe 104 which is couple to an inlet pipe 106. The inlet pipe 106 optionally has a flange 108 for easily coupling the screen 100 to a piping system, for carrying the water to a facility for use. The screens 102 include a series of filter members 110 which run substantially parallel around the circumference of the screen 102. Although shown as running substantially parallel around the screen 102, it should be appreciated that the filter members 110 could be arranged in any manner that blocks debris from entering the screen 102.

The intake filter assembly 100 is shown, in FIG. 1, with a portion of the filter members 110 cut away. The cut away portion shows the interior of the screen having a primary flow modifier 112, a secondary flow modifier 114, a plate 116 which connects the connector pipe 104 to the modifiers 112 and 114, an end cap 117, and a support structure 118. The cut away portion also shows longitudinal supports 120 and circumferential supports 122, which provide basic support for the screen 102 while holding the filter members 110 in place. Although shown as having longitudinal supports and circumferential supports it should be appreciated that the invention could be practiced with only the longitudinal supports 122.

The support structure 118, as shown, consists of a series of helical bars 124 which traverse the screen 102. In one embodiment, a first end 126 of two bars 124 couples to the plate 116 at substantially the same location. The bars 124 then extend toward the end cap 117 in a manner that creates an angle θ1 between the two bars 124, as shown in FIGS. 1 and 2. The bars 124 are arranged to have the same contour as the screen 102 as the bar traverses the screen 102. Thus, the bars 124 are in contact with the screen 102 as the bar extends from the first end of the bar 126 to a second end 128 of the bar. The second end 128 of the bar couples to the cap 117. The bars 124 may be coupled to the plate 116 and the cap 117 by any method known in the art, such as welding, screws, bolts, etc. In one embodiment, the bars 124 at the second end 128 are coupled with a substantially similar angle 02 as the angle θ1 on the first end. With the bars 124 coupled to the plate 116 and the cap 117 at substantially the same location, the bars form a zigzag pattern as they traverse the screen. Although shown as each end of the bars 124 being coupled together at the plate 116 and the cap 117 it should be appreciated that any arrangement could be used so long as the bars 124 traverse the screen 102 in a substantially helical manner.

The angles θ1 and θ2 can be any angle necessary for the operation. The larger the angle, the longer the bars 124 will need to be in order to traverse a longer section of the screen 102. Further, any number of angles θ1 and θ2 could be used, for example angles θ1 and/or θ2 could vary for each new set of bars 124.

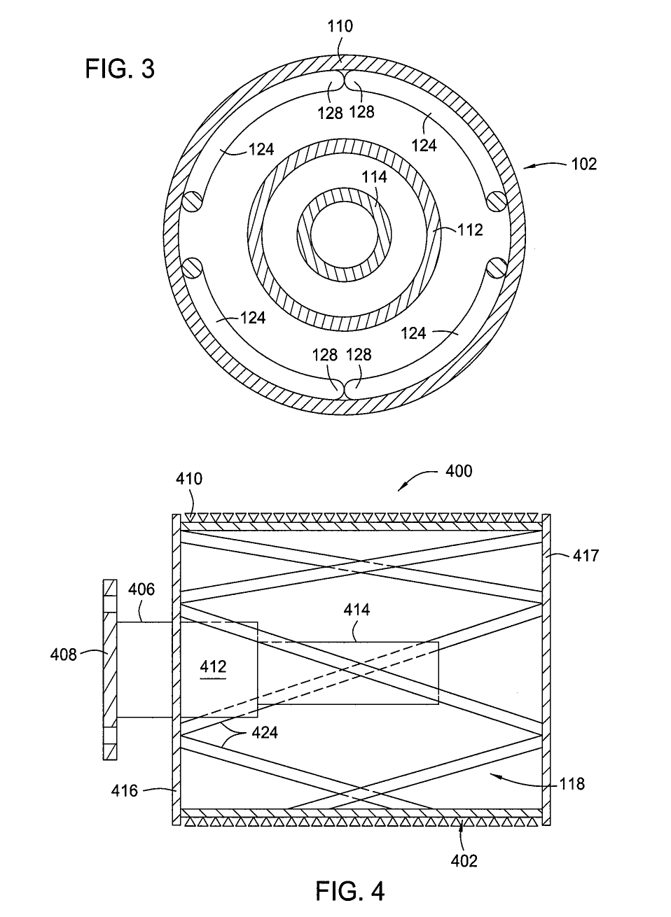

FIG. 3 shows a cross sectional view of the filter assembly 100 according to one embodiment of the present invention. The bars 124 are shown coupled to the interior of the screen 102 and the filter members 110. Although shown as the bars 124 being coupled to the interior of the screen 102, it should be appreciated that the bars 124 may be adapted to couple to the exterior of the screen 102 or be included as an integral part of the screen 102, or coupled to the longitudinal supports 120 or the circumferential supports 122. These longitudinal supports 120 and circumferential supports 122 could be integral with the screen 102, or on the interior or exterior diameter of the screen 102, or any combination thereof. The bars 124 are shown extending from a point just after the first end 126, shown in FIGS. 1 and 2, to the second end 128 where the bars 124 are coupled to the cap 117. The bars 124 may be coupled to the screen 102 by known methods such as welding, screws, bolt, etc. or may simply rest against screen 102. The bars 124 provide extra stiffness for the screen 102 to resist lateral current and intake loads. Further, although the bars 124 are shown as helical members it, should be appreciated that any non-longitudinal arrangement of bars may be used.

The bars 124 are shown, in FIG. 3, as being solid cylindrical members, but could just as effectively be tubular or any long member having a polygonal cross-section, an angle iron, a channel, etc.

FIG. 4 shows another embodiment of a filter assembly 400, with the filter members 410 shown only cross-sectionally for clarity, having the same support structure 118 as described above. The filter assembly 400 has only one screen 402 with an inlet pipe 406 coupled to a plate 416. The plate 416 couples to the screen 402, which couples to a cap 417. The inlet pipe 406 as above has an optional flange 408 for attaching the filter assembly to a piping system not shown. The filter assembly 400 has a primary flow modifier 412, a secondary flow modifier 414.

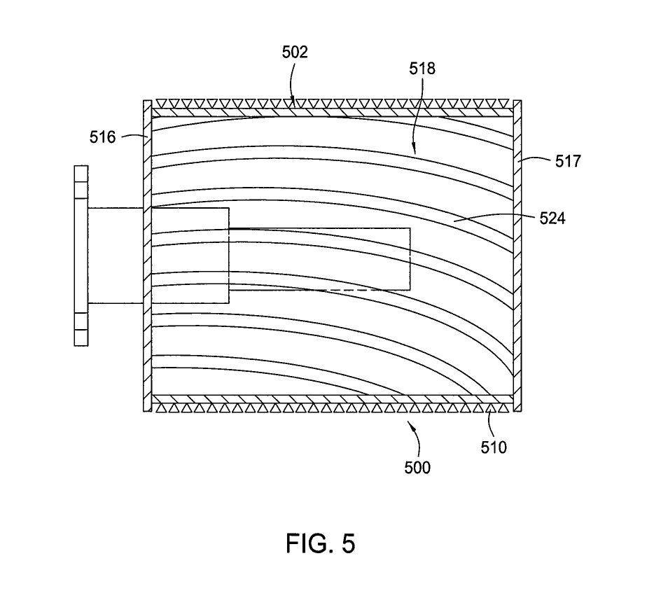

FIG. 5 shows an alternative embodiment of the filter assembly 500. The filter assembly 500 is substantially the same as the embodiments above, however, the support structure 518 consists of a series of helical bars 524 which as above follow the screen 502 but do not meet an the plate 516 and the cap 517.

Each of the filter assemblies above is shown, for simplicity as having a primary flow modifier and a secondary flow modifier. It should be appreciated, however, that any number of flow modifiers and any arrangement contemplated in the art may be used for the modifiers. Examples of cylindrical screens with flow modifiers are shown in U.S. Pat. No. 6,051,131 to Maxson, and U.S. Pat. No. 6,712,959 to Ekholm, et al., the disclosures of which are incorporated by reference herein in their entirety.

Further, it is contemplated, in an alternative embodiment, that the support bars 124 run in a non-longitudinal straight line from the plate 116 to the cap 117. Thus, two or more bars 124 would attach to the plate 116 and the cap 117 at different longitudinal locations and act as cross-bracing for the screen 102.

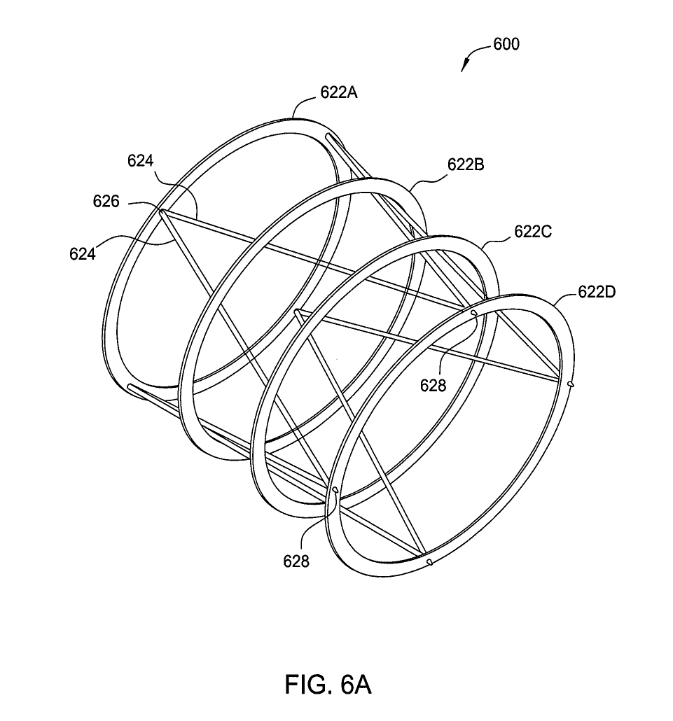

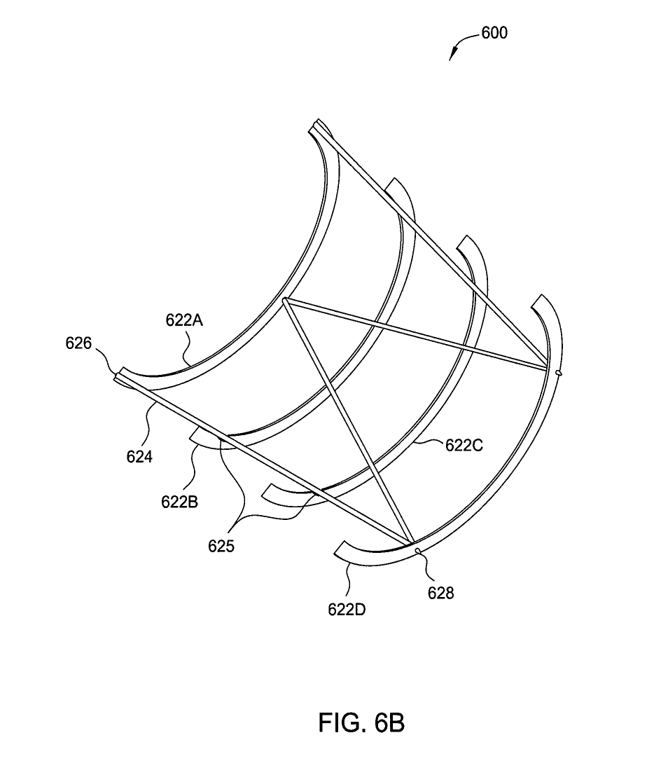

Nom FIGS. 6A and 6B illustrate a support structure 600 that may be used with the embodiments of the filter assemblies 100, 400, 500 described herein and vice versa. The support structure 600 may include one or more circumferential supports 622A-D (such as circumferential supports 122) and one or more bars 624 (such as longitudinal supports 120 and/or bars 124, 524). The support structure 600 may be coupled at one end directly to an intake member, such as the connector pipe 104, and/or via a support member, such as plate 116. A closure member, such as end cap 117, may also be coupled to the support structure 600 at an opposite end. A plurality of screen members, such as wires or filter members 110, may also be coupled to the support structure 600 to filter fluid flow into the support structure 600. In one embodiment, one, two, or more support structures 600 (and screen members) may be coupled to an intake member, such as the connector pipe 104, thereby forming a T-shape or other shaped arrangements known in the art.

As illustrated, the bars 624 may comprise straight tubular-type members. The bars 624, however, may be solid, hollow, and/or include circular or polygonal shaped cross sections. A first end 626 of at least two bars 624 may be coupled together and/or at the same location to the circumferential support 622A (and/or the plate 116). The opposite or second end 628 of the at least two bars 624 may be coupled at different locations to the circumferential support 622D (and/or the end cap 117), thereby forming a V-shape or zig-zag configuration. The second end 628 of the at least two bars 624 may be similarly coupled together and/or at the same location to the circumferential support 622D with the ends of two other bars 624. The bars 624 may form a zig-zag pattern around the circumference of the circumferential supports 622A-D. In one embodiment, the bars 624 may be angled and oriented in the same direction around the circumference of the circumferential supports 622A-D. The bars 624 may be arranged in other types of patterns known in the art. The bars 624 provide a truss-type support structure operable resist axial (tension and/or compression) and torsional loads applied to the support structure 600.

The bars 624 may be coupled to the circumferential supports 622A-D in a non-longitudinal straight line. The bars 624 may be disposed at an angle relative to the longitudinal axis of the support structure 600 and/or the central axis of one or more of the circumferential supports 622A-D. The first end 626 and the second end 628 of each bar 624 may be coupled to the circumferential support 622A and the circumferential support 622D, respectively, at different longitudinal locations.

As illustrated in FIG. 6B, the first and second end 626, 628 of the bars 624 may be coupled to the top or bottom surfaces of the circumferential supports 622A, 622D. In one embodiment, the first end 626 of the bars 624 may be coupled closer to (or further from) the outer diameter of the circumferential support 622A, while the second end 628 of the bars may be coupled closer to (or further from) the inner diameter of the circumferential support 622D. In one embodiment, the first end 626 and the second end 628 of the bars 624 may be coupled to the inner and/or outer diameters of the circumferential supports 622A, 622D.

In one embodiment, the bars 624 may contact the inner diameter of the intermediate circumferential supports 622B, 622C that are disposed between the outermost circumferential supports 622A, 622D. In one embodiment, the bars 624 may not contact the inner diameter of the intermediate circumferential supports 622B, 622C. In one embodiment, the circumferential supports 622A-D may include one or more grooves 625 along the inner surface (and/or along the outer surface) for securing and supporting the bars 624 along the longitudinal length of the support structure 600. In one embodiment, the inner (and/or outer) diameter of the intermediate circumferential supports 622B, 622C may be oversized and/or undersized relative to the outermost circumferential supports 622A, 622D to provide and/or prevent contact with the bars 624. In one embodiment, the bars 624 may be disposed through one or more of the circumferential supports 622A-D. In one embodiment, one or more clamp-type members may be used to secure the bars 624 to the circumferential supports 622A-D.

One or more bars 624 may be coupled to the inner diameter and/or outer diameter of one or more circumferential supports 622A-D. In one embodiment, a plurality of screen/filter members, such as wires, ribs, mesh, and/or perforated sheets may be coupled to and supported directly by the outer and/or inner surfaces of one or more bars 624 and/or one or more circumferential supports 622A-D. In one embodiment, one or more components (e.g. bars 124, 624, circumferential supports 122, 622A-D, longitudinal supports 120, plates 116, end caps 117, pipes 104, filter members 110, etc.) of the assemblies described herein may be formed integral with or separate from one or more other components of the assemblies. One more components may be coupled to one or more other components by welded, screwed, and/or bolted connections, by simple contact with (e.g. resting against) another component, and/or by other ways known in the art. One or more of the embodiments described herein may be used in whole or part with one or more other embodiments described herein.

While the foregoing is directed to embodiments of the invention, other and further embodiments of the invention may be devised without departing from the basic scope thereof, and the scope thereof is determined by the claims that follow.

1. A filter assembly, comprising:
an intake member;
a support structure coupled to the intake member, wherein the support structure includes a plurality of bars that extend from a first end of the support structure to a second end of the support structure such that the bars form a zig-zag pattern; and
a plurality of filter members coupled to the support structure for filtering fluid flow into the intake member.

2. The assembly of claim 1, wherein the bars are arranged in a non-longitudinal straight line from the first end to the second end of the support structure.

3. The assembly of claim 1, wherein the bars have a helical configuration.

4. The assembly of claim 1, wherein the support structure includes a plurality of circumferential supports, and wherein the bars are coupled at opposite ends to at least one circumferential support.

5. The assembly of claim 4, wherein first ends of at least two bars are coupled to one circumferential support at the same location.

6. The assembly of claim 5, wherein second ends of the at least two bars are coupled to another circumferential support at different longitudinal locations relative to the first ends.

7. The assembly of claim 1, wherein the filter members are coupled to an exterior of the support structure.

8. The assembly of claim 1, wherein the filter members are coupled to an interior of the support structure.

9. A filter assembly, comprising:
an intake member;
a support structure coupled to the intake member, wherein the support structure includes a plurality of bars that extend from a first end of the support structure to a second end of the support structure in a non-longitudinal straight line; and
a plurality of filter members coupled to the support structure for filtering fluid flow into the intake member.

10. The assembly of claim 9, wherein the bars form a zig-zag pattern around a circumference of the support structure.

11. The assembly of claim 9, wherein the support structure includes a plurality of circumferential supports, and wherein the bars are coupled at opposite ends to at least one circumferential support.

12. The assembly of claim 11, wherein first ends of at least two bars are coupled to one circumferential support at the same location.

13. The assembly of claim 12, wherein second ends of the at least two bars are coupled to another circumferential support at different longitudinal locations relative to the first ends.

14. The assembly of claim 9, wherein the filter members are coupled to an exterior of the support structure.

15. The assembly of claim 9, wherein the filter members are coupled to an interior of the support structure.

16. The assembly of claim 9, further comprising two support structures coupled to the intake member, thereby forming a T-shaped arrangement.
